(19) United States
(12) Patent Application Publication
(10) Pub. No.: US 2012/0127311 A1
(43) Pub. Date: May 24, 2012

(54) METHOD FOR CALIBRATING AN IMAGE RECORDING SYSTEM IN A MOTOR VEHICLE

(76) Inventors: Heiko Gerald RUTH, Stuttgart (DE); Paul RUHNAU, Ditzingen (DE); Frank BERUSCHA, Bietigheim-Bissingen (DE)

(21) Appl. No.: 13/296,814

(22) Filed: Nov. 15, 2011

Related U.S. Application Data
(63) Continuation of application No. 13/121,457.

(30) Foreign Application Priority Data
Oct. 1, 2008 (DE) 10 2008 042 537.0

(51) Int. Cl. H04N 7/18

(52) U.S. Cl. 348/148; 348/E07.085

(57) ABSTRACT

A method for calibrating an image recording system in a motor vehicle, image data being recorded via a camera system from an area which is illuminated by a lighting unit of the motor vehicle, and a modulation of the radiation emitted by the lighting unit being performed to determine the illuminated area.

### CROSS-REFERENCE TO RELATED APPLICATIONS

This application is a continuation of U.S. patent application Ser. No. 13/121,457 filed on Mar. 29, 2011 which was filed as a PCT application PCT/EP2009/061563 on Sep. 7, 2009, which claims foreign priority benefits under 35 U.S.C. §119 to German Patent Application No. 10 2008 042 537.0, filed on Oct. 1, 2008, all of which are hereby incorporated by reference in their entirety.

### BACKGROUND INFORMATION

In current luxury class vehicles, camera systems, which support the driver in lane and/or object recognition, for example, and furthermore make night driving easier through the implementation of night vision functions, have been used for some time. Such systems are described, for example, in European Patent Application No. EP 1 470 706. In addition, adaptive lighting systems, in which the illuminated area of the lighting unit of the vehicle, for example, the headlights, is adapted to the particular driving situation, have recently increasingly been used. This may be performed in the horizontal direction by the implementation of a cornering light and also in the vertical direction as an adaptive front light, for example. Corresponding systems are described in European Patent Application No. EP 0 869 031.

The image data recorded by the camera are often processed further using a microprocessor for driver assistance applications and analyzed for relevant information from the surroundings, such as traffic signs or the surrounding vehicles or weather situation.

However, errors regularly occur, which may originate from reflections of external light, for example. Furthermore, for various applications of driver assistance systems, such as fog recognition, exact knowledge of the light distribution of the vehicle's own lighting unit, i.e., the vehicle headlights, is required. It is to be ensured in particular in this case that the radiation originating from light sources other than the vehicle's own lighting unit is not incorrectly recognized as radiation of the vehicle's own lighting unit, which would result in errors in the analysis.

In addition, for example, in the scope of a night vision functionality, a model of the light distribution generated by the vehicle's own lighting unit is often used as the basis for the image analysis. It may be used for the purpose of adapting the image brightness in the vehicle-side output unit and thus compensating for the significantly brighter illumination near the vehicle by the dimmed headlights, for example.

### SUMMARY OF THE INVENTION

Because a modulation of the emitted radiation is performed to determine the area illuminated by the lighting unit of the motor vehicle, the illuminated area may be reliably recognized. Since the type of modulation is known to the system, the parts affected by the known modulation may be assigned to the area illuminated by the vehicle's own lighting unit.

Various types of modulation are possible; for example, it is advantageous to perform an intensity modulation up to a pulsed illumination of the illuminated area. The illuminated area may subsequently be precisely determined by appropriate filtering in an analysis unit. In addition, it is possible in this variant of the present invention to increase the signal-to-noise ratio, similarly to the application of a lock-in technique.

Alternatively or additionally, the modulation may be a spatial modulation, in particular pivoting of the lighting unit, for example, the vehicle headlights, around a horizontal axis or a vertical axis or also combined pivoting around both axes. A pivot program having specified deflections, speeds, and directions may be stored in the analysis unit of the image processing unit, for example, and used for the purpose of moving the light cone by corresponding activation of the headlight control unit. The image processing unit may subsequently determine the area illuminated by the vehicle's own lighting unit on the basis of the previously known movement.

The method according to the present invention has the advantage that the recognition of the light emitted by the vehicle's own lighting unit is more reliable and simpler, which results in a reduction of possible error sources in the case of the subsequent image processing functions.

Functions such as fog recognition may operate more precisely, since it may be presumed that the present invention allows the vehicle's own light to be reliably recognized, so that fog may be more reliably recognized and quantified from measured light attenuation by scattering, for example. Furthermore, the method according to the present invention also allows the light distribution generated by the vehicle headlights to be determined at any time during travel.

The method according to the present invention may particularly also be used for the purpose of determining the image area illuminated by the lighting unit of the vehicle for a night vision system. This allows the particularly bright image area which is illuminated by the vehicle's own headlights to be determined more exactly and therefore to be attenuated more exactly for the display on an image output unit. As a result, an improved image may thus be displayed to the vehicle driver.

In addition, a visibility determination may be performed using the method according to the present invention. This may be performed, for example, in that the image recording system may cause the lighting unit to variably change the light range. A comparison of the measured values to the stored illumination range values may then be used for the visibility recognition.

In a further variant of the present invention, a function check of the lighting unit may be performed using the method according to the present invention. For this purpose, for example, a deviation of the current illumination from the typical illumination may be recorded, for example, if no change of the illumination is recorded in the area in front of a headlight in the case of a movement of the headlight, soiling or a defect of the headlight may be concluded therefrom. Headlight cleaning may subsequently be performed automatically or in a user-controlled manner, for example.

Conversely, the method according to the present invention may also be used for performing a function check of the camera system. For this purpose, in the case in which the camera does not recognize the expected light distribution change in spite of correct resistance of the headlights and an appropriate switch position, it may be concluded that the camera system is defective.

In addition, the method according to the present invention may obtain parameters for verifying the entire recorded image. In other words, assistance functions such as the recognition of fog may use the knowledge of the vehicle's own light distribution. As a result, the overall image is improved with respect to its probability of error and its information content.

Furthermore, the method according to the present invention may be used in the context of the adaptation of the lighting unit to cornering. In other words, the knowledge of the imminent pivot of the headlights may advantageously be used in the image recording system.

### BRIEF DESCRIPTION OF THE DRAWINGS

FIGS. 1a through 1d show various stages of the calibration.

FIGS. 2a and 2b show a schematic view of the present invention in partial FIGS. 2a through 2b.

### DETAILED DESCRIPTION

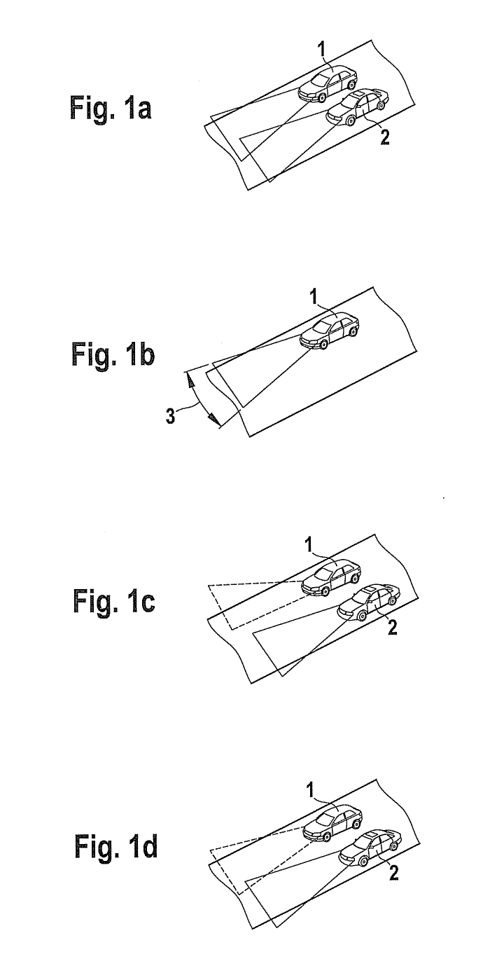

FIG. 1a shows the situation in which the area illuminated by the host vehicle overlaps with that of another vehicle 2. In this situation, it may not be reliably established initially without further measures which part of the illuminated area originates from the vehicle's own lighting unit.

In FIG. 1b, the area illuminated by vehicle 1 is pivoted in the horizontal direction as indicated by arrow 3, whereby it is possible to determine the area illuminated by the vehicle using the image recording unit. In this way, a frame may be drawn by the software around the area illuminated by the vehicle's own headlights, as shown in FIG. 1c. The information about the area illuminated by the vehicle which is thus recognized, shown by dashed lines in FIG. 1c, may then be used for the further image analysis.

FIG. 1d shows the situation in which an overlap of the area illuminated by the host vehicle with external light from external vehicle 2 is possible. However, the probability of error due to the external light of vehicle 2 is significantly reduced by the previously performed calibration. In particular, after the calibration, the illuminated areas whose illumination does not originate from the lighting unit may be excluded from the further analysis.

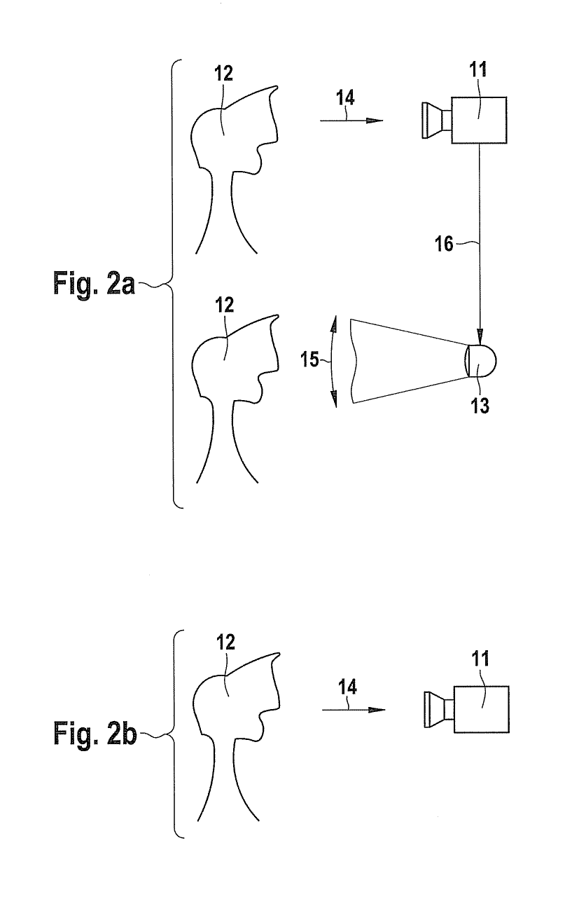

The principle of the present invention will be explained once again on the basis of the schematic view in FIGS. 2a and 2b. FIG. 2a shows the situation in which scene 12 is recorded by camera system 11, which is indicated by arrow 14. To calibrate the image recording system, the control signal indicated by arrow 16 is output by camera system 11 to lighting unit 13, which is designed as headlights. The control signal causes lighting unit 13 to pivot the light cone generated thereby, which is shown by arrow 15. On the basis of a further recording of the image of scene 12—shown in FIG. 2b—under the new, known lighting conditions, the area which is illuminated by the vehicle's own lighting unit 13 may be reliably determined.

1-11. (canceled)

12. A method for calibrating an image recording system in a motor vehicle, the method comprising:
recording image data from an area illuminated by a lighting unit of the motor vehicle via a camera system; and
performing a modulation of radiation emitted by the lighting unit to determine the illuminated area.

13. The method according to claim 12, wherein the modulation is an intensity modulation.

14. The method according to claim 12, wherein the modulation is a spatial modulation.

15. The method according to claim 14, wherein the modulation is performed by pivoting the lighting unit around a horizontal axis or a vertical axis or by combined pivoting around both axes.

16. The method according to claim 12, wherein the image area illuminated by the lighting unit is determined using a method for a night vision system.

17. The method according to claim 12, wherein a visibility determination is performed using the method.

18. The method according to claim 12, wherein a function check of the lighting unit is performed using the method.

19. The method according to claim 12, wherein a function check of the camera system is performed using the method.

20. The method according to claim 12, wherein parameters for verifying an entire recorded image are obtained using the method.

21. The method according to claim 12, wherein the modulation is performed in the scope of an adaptation of the lighting unit to cornering.

22. An image recording system in a motor vehicle, comprising:
a lighting unit;
a camera system for recording image data from an area being illuminated by the lighting unit of the motor vehicle; and
an arrangement for performing a modulation of radiation emitted by the lighting unit to determine the illuminated area.
